(19) United States
(12) Patent Application Publication
(10) Pub. No.: US 2024/0251157 A1
(43) Pub. Date: Jul. 25, 2024

(54) IMAGING APPARATUS

(71) Applicant: Panasonic Intellectual Property Management Co., Ltd., Osaka (JP)

(72) Inventor: Takashi SUZUKI, Osaka (JP)

(73) Assignee: Panasonic Intellectual Property Management Co., Ltd., Osaka (JP)

(21) Appl. No.: 18/411,604

(22) Filed: Jan. 12, 2024

(30) Foreign Application Priority Data
Jan. 19, 2023 (JP) 2023-006638
Nov. 2, 2023 (JP) 2023-188374

(51) Int. Cl. H04N 23/60; H04N 13/207; H04N 13/296; H04N 23/63

(52) U.S. Cl. CPC H04N 23/64; H04N 13/207; H04N 13/296; H04N 23/632; H04N 23/635

(57) ABSTRACT

An imaging apparatus for causing a user to perform image shooting for modeling of a subject, the imaging apparatus includes: an image sensor configured to capture an image of a subject to generate image data; an output interface configured to output information to the user; and a controller configured to recognize a situation in which image shooting operation is executed by the imaging apparatus, to control the output interface, the image shooting operation including a plurality of times of imaging by the image sensor for modeling the subject, wherein the controller is configured to cause the output interface to output shooting guide information, according to the recognized situation in the image shooting operation, the shooting guide information guiding the user to succeed in shooting of each of a plurality of images for modeling of the subject.

### TECHNICAL FIELD

The present disclosure relates to an imaging apparatus that performs image shooting operation for modeling a subject.

### BACKGROUND ART

JP 2017-227608 A discloses a three-dimensional data generation device that shoots a three-dimensional object and generates three-dimensional data of the object, and an imaging apparatus used for the three-dimensional data generation device. A three-dimensional data generation device includes an image sensor for imaging a subject, a distance information acquiring unit that acquires distance information to the subject, a determining unit for determining an undetermined distance region for which distance information is not acquired on a subject, and a notifying unit for notifying the user of the undetermined distance region. The three-dimensional data generation device notifies a region for which distance information is not acquired on a subject, so as to prompt the user to perform shooting again.

### SUMMARY

The present disclosure provides an imaging apparatus capable of performing image shooting that facilitates modeling of a subject.

In one aspect of the present disclosure, an imaging apparatus for causing a user to perform image shooting for modeling of a subject, the imaging apparatus includes: an image sensor configured to capture an image of a subject to generate image data; an output interface configured to output information to the user; and a controller configured to recognize a situation in which image shooting operation is executed by the imaging apparatus, to control the output interface, the image shooting operation including a plurality of times of imaging by the image sensor for modeling the subject, the controller is configured to cause the output interface to output shooting guide information, according to the recognized situation in the image shooting operation, the shooting guide information guiding the user to succeed in shooting of each of a plurality of images for modeling of the subject.

In another aspect of the present disclosure, an imaging apparatus for performing image shooting for modeling of a subject, the imaging apparatus includes: an image sensor configured to capture an image of a subject to generate image data; and a controller configured to control image shooting operation for modeling of the subject, the image shooting operation including a plurality of times of imaging based on predetermined shooting setting for a plurality of shooting portions in the subject, wherein in addition to the image shooting based on the predetermined shooting setting, the controller is configured to control the image shooting operation to perform additional image shooting with respect to a specific shooting portion among the plurality of shooting portions, the additional image shooting based on additional shooting setting that is different from the predetermined shooting setting, and the specific shooting portion has a feature amount for modeling that is less than a predetermined value in an image shot based on the predetermined shooting setting.

According to the imaging apparatus of the present disclosure, image shooting that facilitates modeling of a subject can be performed.

### BRIEF DESCRIPTION OF DRAWINGS

FIG. 1 is a diagram for explaining an imaging system according to a first embodiment of the present disclosure;

FIG. 2 is a diagram illustrating a configuration of a digital camera according to the first embodiment;

FIG. 3 is a flowchart illustrating a scan shooting operation by the digital camera;

FIGS. 4A to 4C are diagrams for explaining a subject map in the scan shooting operation;

FIG. 5 is a flowchart illustrating shooting guide processing by the digital camera;

FIG. 6 is a diagram for explaining a direction guide in the shooting guide processing;

FIGS. 7A to 7C are diagrams illustrating a display example in the shooting guide processing;

FIG. 8 is a flowchart illustrating thinning storage processing by the digital camera;

FIG. 9 is a diagram for explaining a variation of an imaging system;

FIG. 10 is a flowchart illustrating the scan shooting operation by the digital camera according to a second embodiment; and

FIG. 11 is a diagram illustrating an example of guide display in the digital camera of the second embodiment.

### DETAILED DESCRIPTION

Hereinafter, an embodiment will be described in detail with reference to the drawings as appropriate. However, detailed description of an already well-known matter and overlapping description for substantially the same configuration may be omitted. Note that the accompanying drawings and description below are provided to enable those skilled in the art to sufficiently understand the present disclosure, and these are not intended to limit the subject matter described in the claims.

### First Embodiment

### 1. Configuration

### 1-1. System Overview

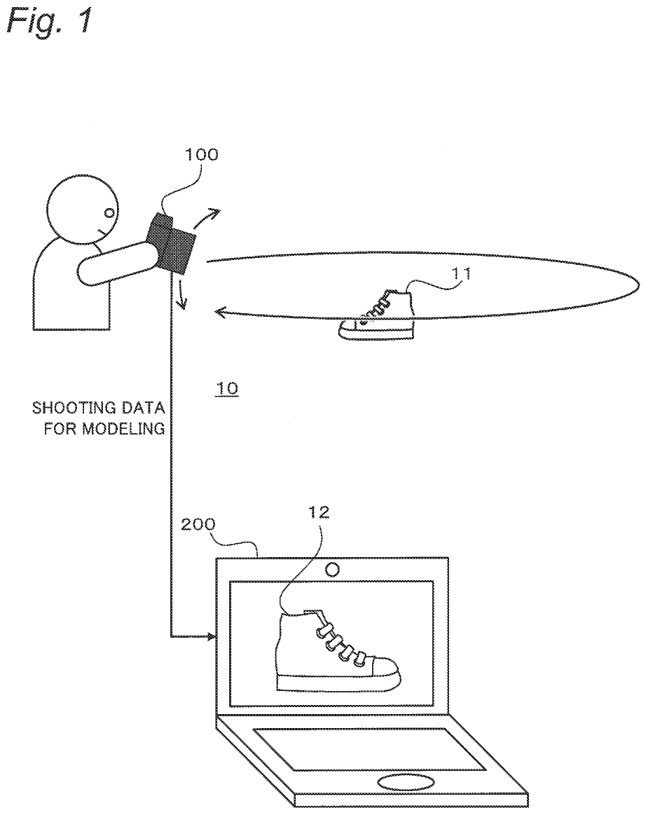

The imaging system according to the first embodiment of the present disclosure will be described with reference to FIG. 1.

As illustrated in FIG. 1 an imaging system 10 according to the present embodiment includes a digital camera 100 and an image editing personal computer (PC) 200, for example. The present system 10 performs information processing for modeling that reproduces a three-dimensional shape, texture, and the like of a subject 11 desired by the user by e.g. a photogrammetry technique for analyzing a result of image shooting by the digital camera 100.

FIG. 1 illustrates an example in which the user of the digital camera 100 performs image shooting around the desired subject 11 such as shoes. In the present system 10, the image editing PC 200 performs modeling processing on the basis of such a shooting result, so that a subject model 12 indicating an image of the subject 11 viewed from an optional direction is generated, for example.

The subject model 12 is applicable to, for example, an application for enhancing reality in a product image for checking of an appearance of a product (the subject 11) online in E-commerce. For example, a conventional product image with low reality is difficult to reproduce a state such as a scratch or dirt on a product such as a reusable product, and deviation between a product image before purchase and an actual product after purchase is significant. Such deviation causes burden on both a purchaser and a seller in handling of a product return, for example.

In view of the above, the present system 10 can reduce deviation from an actual product by reproduction of a state and texture of a product and the like, which are difficult in a conventional product image, by using image shooting of the digital camera 100 for input of modeling processing with an E-commerce product as the subject 11, for example. In this way, the present system 10 can easily visualize a product value for a purchaser by enhancing reality of a product image, and is also helpfully usable for a seller.

### 1-2. Configuration of Digital Camera

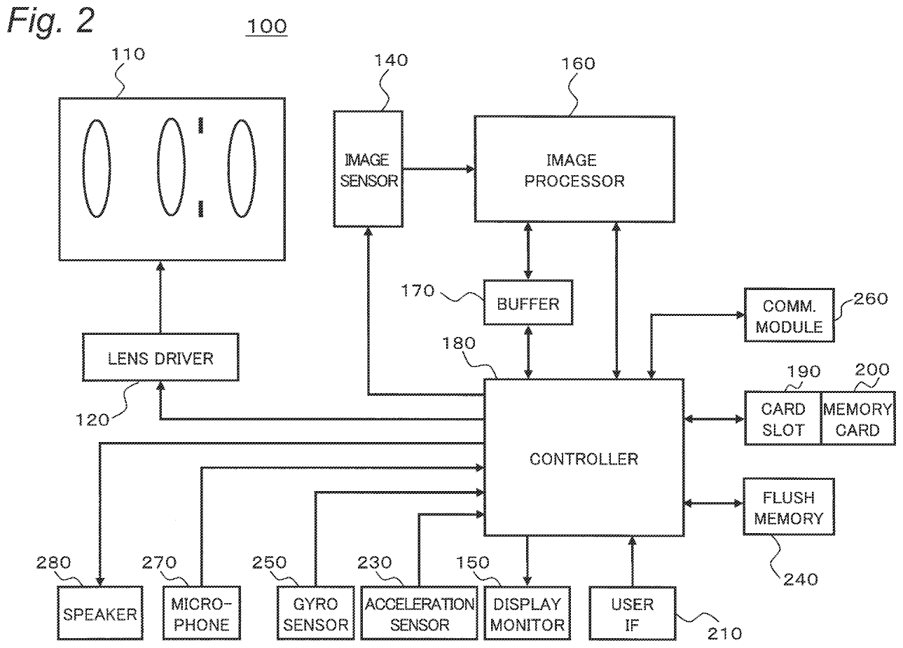

A configuration of a digital camera according to the first embodiment will be described with reference to FIG. 2.

FIG. 2 is a diagram illustrating a configuration of the digital camera 100 according to the present embodiment. The digital camera 100 of the present embodiment includes an optical system 110, a lens driver 120, and an image sensor 140. Further, the digital camera 100 includes an image processor 160, a buffer memory 170, a controller 180, a user interface 210, a display monitor 150, an acceleration sensor 230, and a gyro sensor 250. The digital camera 100 further includes a flash memory 240, a card slot 190, a communication module 260, a microphone 270, and a speaker 280.

The optical system 110 includes a zoom lens, a focus lens, and the like. The zoom lens is a lens for changing magnification of a subject image formed by the optical system. The focus lens is a lens for changing the focus state of the subject image formed on the image sensor 140. The zoom lens and the focus lens are formed of one or more lenses.

The lens driver 120 includes a configuration for driving various lenses of the optical system 110 such as a focus lens. For example, the lens driver 120 includes a motor, to move the focus lens along the optical axis of the optical system 110 based on the control of the controller 180. The configuration for driving the focus lens in the lens driver 120 can be implemented with a DC motor, a stepping motor, a servo motor, an ultrasonic motor, or the like.

The image sensor 140 captures a subject image incident through the optical system 110 and generates image data. The image data generated by the image sensor 140 is input to the image processor 160.

The image sensor 140 generates image data on a new frame at a predetermined frame rate (e.g., 30 frames/second). The imaging data generation timing and electronic shutter operation in the image sensor 140 are controlled by the controller 180. As the image sensor 140, various image sensors such as a CMOS image sensor, a CCD image sensor, or an NMOS image sensor can be used.

The image sensor 140 executes imaging operation of a moving image or a still image, imaging operation of a live view image, and the like. The live view image is mainly a moving image, and is displayed on the display monitor 150 for the user to determine a composition. The image sensor 140 is an example of an image sensor in the present embodiment.

The image processor 160 performs predetermined processing on the image signal output from the image sensor 140 to generate image data, or performs various processing on the image data to generate an image to be displayed on the display monitor 150. The predetermined processing includes white balance correction, gamma correction, YC conversion processing, electronic zoom processing, compression processing, expansion processing, and the like, but is not limited to these. The image processor 160 may be configured with a hard-wired electronic circuit, or may be configured with a microcomputer, a processor, or the like using a program.

The buffer memory 170 is a recording medium that functions as a work memory for the image processor 160 and the controller 180. The buffer memory 170 is implemented with a dynamic random-access memory (DRAM) or the like. The flash memory 240 is a non-volatile recording medium. Each of the memories 170 and 240 is an example of a memory in the present embodiment.

The controller 180 controls the overall operation of the digital camera 100. The controller 180 uses the buffer memory 170 as a work memory for a control operation or an image processing operation.

The controller 180 includes a CPU or an MPU, and the CPU or MPU achieves a predetermined function by executing a program (software). The controller 180 may include a processor including a dedicated electronic circuit designed to achieve a predetermined function instead of the CPU or the like. That is, the controller 180 can be implemented with various processors such as a CPU, an MPU, a GPU, a DSP, an FPGA, and an ASIC. The controller 180 may include one or more processors.

The card slot 190 can mount the memory card 200, and accesses the memory card 200 based on the control from the controller 180. The digital camera 100 can record image data on the memory card 200 and read the recorded image data from the memory card 200.

The user interface 210 is a generic term for operation members that receive an operation (instruction) from a user. The user interface 210 includes a button, a lever, a dial, a touch panel, a switch, and the like for receiving a user operation, and includes, for example, a moving image recording button, a function button, and the like. The user interface 210 may also include a virtual button or icon displayed on the display monitor 150 or the like.

The display monitor 150 is an example of a display that displays various information (eventually, an example of an output interface). For example, the display monitor 150 displays an image (live view image) indicated by image data captured by the image sensor 140 and subjected to image processing by the image processor 160. In addition, the display monitor 150 displays a menu screen or the like for the user to perform various settings on the digital camera 100. The display monitor 150 can be configured by, for example, a liquid crystal display device or an organic EL device.

The acceleration sensor 230 detects one or more accelerations in three axial directions orthogonal to each other, that is, a speed change per unit time, for example. The acceleration sensor 230 outputs acceleration information indicating a detection result to the controller 180. The acceleration sensor 230 is an example of a detector in the present embodiment.

In the digital camera 100, the gyro sensor 250 detects one or more angular velocities of the yaw direction, the pitch direction, and the roll direction, that is, an angular change per unit time, for example. The gyro sensor 250 outputs gyro information indicating a detection result to the controller 180. The gyro sensor 250 is an example of a detector in the present embodiment.

The communication module 260 is a module (circuit) that performs communication conforming to the communication standard IEEE 802.11 or a standard such as Wi-Fi or Bluetooth. The digital camera 100 may communicate directly with other devices via the communication module 260 or may communicate with other devices via an access point. The communication module 260 may be connectable to a communication network such as the Internet. The digital camera 100 may further include a positioning module (an example of a detector) that performs positioning based on information received from a GPS satellite or the like. The communication module 260 is an example of a connecter (eventually, an example of an output interface) that is communicably connected to various external devices.

The microphone 270 is an example of a detector that includes one or more microphone elements built in the digital camera 100 and collects sound outside the digital camera 100, for example. The microphone 270 outputs a sound signal indicating the collected sound to the controller 180. An external microphone may be used in the digital camera 100. The digital camera 100 may include a connecter such as a terminal connected to an external microphone as a detector alternatively or additionally to the built-in microphone 270.

The speaker 280 is an example of an output interface that includes one or more speaker elements built in the digital camera 100, for example. The speaker 280 outputs sound to the outside of the digital camera 100 under the control of the controller 180. For the digital camera 100, an external speaker, an earphone, or the like may be used. The digital camera 100 may include a connecter connected to an external speaker or the like as an output interface alternatively or additionally to the built-in speaker 280.

### 2. Operation

Operation of the imaging system 10 and the digital camera 100 according to the present embodiment will be described below.

The digital camera 100 of the present system 10 (FIG. 1) executes operation for causing the user to shoot various images of the subject 11 in moving image shooting, for example (hereinafter referred to as “scan shooting operation”). In the scan shooting operation of the present embodiment, the digital camera 100 generates shooting data to be used for input of modeling processing on the basis of a shot moving image. The scan shooting operation of the present embodiment is an example of image shooting operation for modeling of the subject 11.

In the present system 10, shooting data for modeling generated by the digital camera 100 as described above is input to the image editing PC 200 via a portable recording medium by the user or by wired or wireless data communication, for example. The image editing PC 200 executes modeling processing based on input shooting data for modeling to generate the subject model 12.

For example, the modeling processing in the present system 10 includes alignment processing of estimating a positional relation between the digital camera 100 and the subject 11 at the time of shooting of an image for each frame, and processing of extracting a feature point of the subject 11 in the image as point cloud data. In the modeling processing, mesh data indicating a three-dimensional shape of the subject 11 is formed from various information obtained as the above, and texture data indicating texture of each portion of the subject 11 is constructed. The subject model 12 includes such mesh data and texture data, for example.

In such modeling processing, it is presumed that processing accuracy is lowered or a processing load increases when shooting accuracy of the image as input is low. Some difficulty may be concerned to perform the modeling processing also when a data amount of an imaging result is unnecessarily large. In view of the above, for facilitating such modeling processing, the digital camera 100 of the present embodiment performs, as preprocessing, the scan shooting operation to obtain an image in which the subject 11 is shot with high accuracy.

### 2-1. Scan Shooting Operation

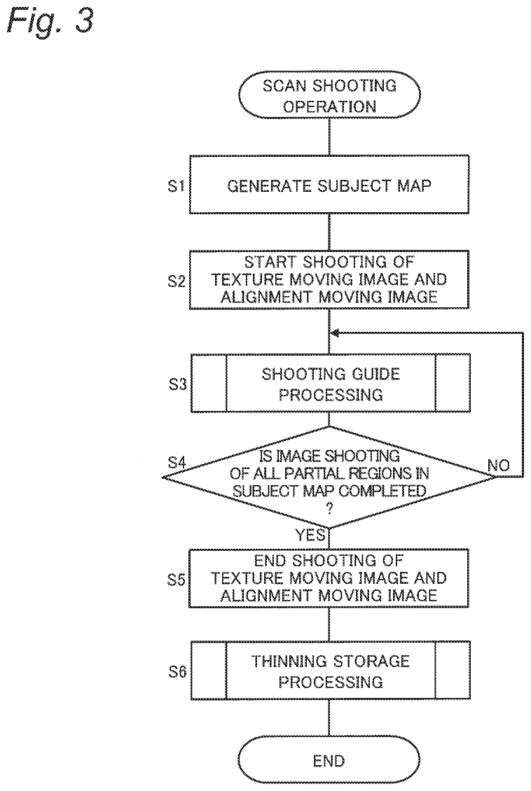

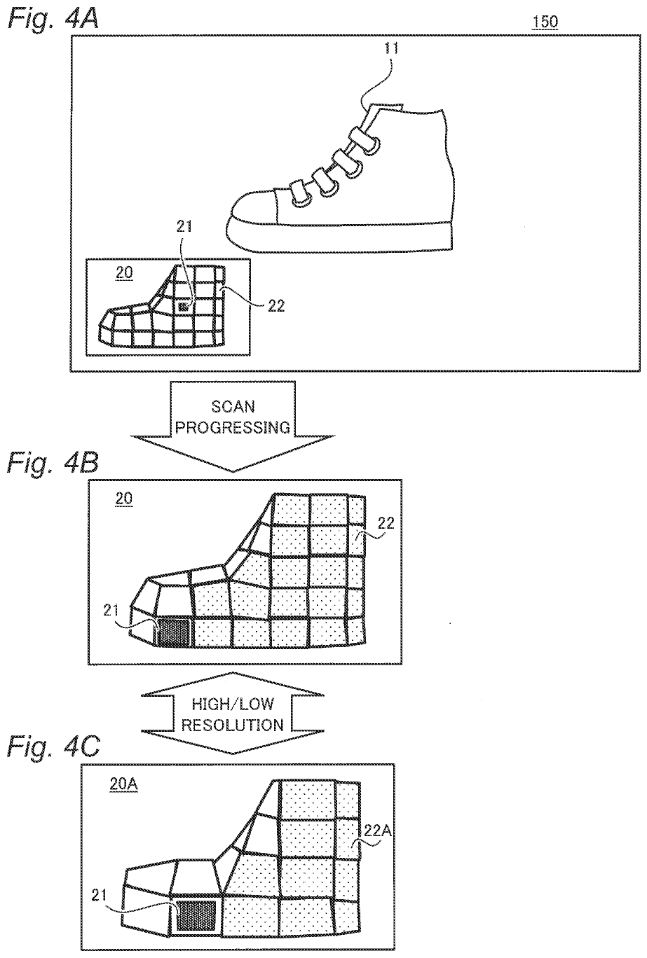

The scan shooting operation in the present system 10 will be described with reference to FIGS. 3 to 4.

FIG. 3 is a flowchart illustrating the scan shooting operation by the digital camera 100. For example, the process of FIG. 3 is started when the user shoots a moving image of the subject 11 with the digital camera 100 as illustrated in FIG. 1. Each piece of processing illustrated in the present process is executed by the controller 180 of the digital camera 100, for example.

First, in the digital camera 100 according to the present embodiment, the controller 180 generates a subject map that is map information for comprehensively guiding the user to shoot images of various portions of the subject 11 according to the subject 11 that is a target of the scan capture operation (S1). FIGS. 4A to 4C are diagrams for explaining a subject map 20 in the scan shooting operation.

FIG. 4A illustrates a display example of the display monitor 150 at an initial stage of the scan shooting operation for the subject 11 in FIG. 1. The display monitor 150 displays the subject map 20 superimposed on a live view image of the digital camera 100, for example.

As exemplified in FIG. 4A, the subject map 20 includes a shooting pointer 21 and a plurality of partial regions 22. The shooting pointer 21 indicates a position corresponding to an image being shot by the digital camera 100 in the subject map 20. A plurality of the partial regions 22 indicate a plurality of portions where images are to be shot on the subject map 20 in the scan shooting operation.

As exemplified in FIG. 4A, the subject map 20 of the present embodiment has an entire shape along a three-dimensional shape of the subject 11, and is configured by arranging a plurality of the partial regions 22 dividing the entire shape. For example, each partial region 22 indicates a portion assumed to be used for texture data of the subject model 12 in a corresponding shot image. The partial regions 22 in the subject map 20 have a common size from the viewpoint of aligning resolution of each portion in the subject model 12, for example.

For example, the processing in Step S1 is performed as the digital camera 100 automatically recognizes an attribute or the like of the subject 11 in focus on the basis of a live view image in response to the user bringing the digital camera 100 into focus on the desired subject 11. For such image recognition, a machine learning model for autofocus operation can be used, for example. Based on information obtained by image recognition of the subject 11, the controller 180 creates the subject map 20 similar to a shape of the subject 11 (S1), and updates the subject map 20 as needed during the scan shooting operation.

In a process of FIG. 3, the controller 180 of the digital camera 100 starts shooting of a moving image for modeling the subject 11 (S2). In such moving image shooting (S2 to S5), the digital camera 100 according to the present embodiment simultaneously shoots a texture moving image and an alignment moving image as a plurality of moving images having different image qualities for each application in modeling processing, for example.

A texture moving image includes an image used for construction of texture data in the subject model 12 in modeling processing. For an image for texture, image quality desired by the user for the subject model 12 is used, for example. In Step S2, the controller 180 initially adjusts shooting settings such as resolution and exposure in imaging for each frame in moving image shooting, according to image quality of an image for texture, for example.

An alignment moving image includes an image used for alignment processing in modeling processing, feature point extraction processing, and the like. For an image for alignment, suitable image quality is used from the viewpoint of accuracy of the above processing and a processing load, for example. For example, resolution of an image for alignment can be set to be lower than resolution of an image for texture. An alignment moving image may be obtained as proxy recording for a texture moving image in the digital camera 100. Each moving image has a resolution of e.g. FHD, 4K, 6K, or 8K.

During moving image shooting started in Step S2, the controller 180 executes processing of guiding the user to accurately shoot an image of the subject 11 by using the subject map 20, for example (S3). A display example of the subject map 20 in such shooting guide processing (S3) is illustrated in FIG. 4B.

FIG. 4B illustrates an example in which the partial region 22 as a part of the subject map 20 illustrated in FIG. 4A is updated as being already shot. In the shooting guide processing (S3) of the present embodiment, updating to make a display attribute such as a color of the partial region 22 that is already shot in the subject map 20 different from a display attribute of the partial region 22 that is yet to be shot is sequentially performed. In this way, it is possible to guide the user to shoot an image of the partial region 22 that is yet to be shot.

In the example of FIG. 4B, a case where a shooting distance between the digital camera 100 and the subject 11 is shorter than that in the example of FIG. 4A will be exemplified. In this case, the size of the shooting pointer 21 is displayed larger. In the shooting guide processing (S3) of the present embodiment, for each of the partial regions 22 in the subject map 20, the controller 180 presents, to the user, various shooting guide information for the user to succeed in shooting in which shooting accuracy of an image is secured for the partial region 22, for example. Details of the shooting guide processing (S3) will be described later.

For example, the controller 180 determines whether or not image shooting of all the partial regions 22 in the subject map 20 is completed (S4). In a case where image shooting of all the partial regions 22 is not completed (NO in S4), the controller 180 performs the shooting guide processing (S3) again for the partial region 22 for which image shooting is not completed. In the digital camera 100 of the present embodiment, the scan shooting operation proceeds along the subject map 20 as the shooting guide processing (S3) is repeated.

For example, when image shooting of all the partial regions 22 is completed (YES in S4), the controller 180 ends shooting of a texture moving image and an alignment moving image (S5). The controller 180 stores each piece of moving image data, for example, in the buffer memory 170 in order to temporarily store (i.e., hold) the moving image data, for example.

Next, in the digital camera 100 according to the present embodiment, the controller 180 performs processing of storing shooting data for modeling from each shot moving image (S6). In thinning storage processing (S6) of the present embodiment, an image presumed to be unnecessary in the modeling processing is thinned out from a texture moving image and an alignment moving image, and shooting data for modeling is stored. Details of the thinning storage processing (S6) will be described later.

The controller 180 of the digital camera 100 stores the shooting data for modeling (S6), and ends the processing illustrated in the process of FIG. 3. After the above, for example, when shooting data for modeling is input to the image editing PC 200, modeling processing of the subject 11 is performed, and the subject model 12 is obtained.

According to the above scan shooting operation, a guide for seamlessly obtaining a shooting result suitable for modeling the subject 11 with high accuracy in moving image shooting is provided to the user (S1 and S3), and data acquisition suitable for modeling processing can be performed (S2 to S6). In this way, the digital camera 100 of the present embodiment can realize image shooting for facilitating modeling of the subject 11 for both the image editing PC 200 and the user, for example.

### 2-1-1. Subject Map

In the subject map 20 created in Step S1, size of the partial region 22 is set in advance according to resolution required for texture data of the subject model 12, for example. For example, the number of the partial regions 22 in the subject map 20 corresponds to the number of images included in shooting data for modeling. FIG. 4C illustrates a variation of the subject map 20.

FIG. 4C exemplifies the subject map 20 in a case where resolution of texture data is lower than that in the example of FIG. 4A. For example, the controller 180 sets size of the partial region 22 to be larger as resolution of texture data is lower. In this way, the number of the partial regions 22 in the subject map 20 is reduced, and the number of images included in shooting data for modeling can be reduced. On the other hand, in a case where size of the partial region 22 is set to be small as in the example of FIG. 4A, the subject model 12 can be made high resolution.

In Step S1 described above, an example in which the subject map 20 is created by automatic attribute recognition of the subject 11 by the digital camera 100 is described, but the present disclosure is not limited to this, and the user may designate an attribute of the subject 11. For example, in the digital camera 100, a setting menu or the like for selecting an attribute of various subjects may be provided. For example, an attribute of a subject is selected from a plurality of options in which various objects such as articles like a shoe, plants like a flower, and animals like a cat are classified in advance.

For example, the present system 10 prepares a form of a subject map by machine learning or the like for various attributes of a subject classified in advance, and the controller 180 corrects a map shape of the form by image recognition or the like at the time of the scan shooting operation to create the subject map 20 (S1). Alternatively, such correction may be omitted, and the subject map 20 of the form may be used in the scan shooting operation.

2-1-2. Shooting of Moving Image with Plurality of Image Qualities

In the moving image shooting in Steps S2 to S5, the controller 180 performs image processing of image quality for texture in the image processor 160 on imaged data of an imaging result by the image sensor 140 to generate texture moving image data. The controller 180 may generate alignment moving image data by performing image processing of image quality for alignment in the image processor 160 on the same imaged data, or may generate alignment moving image data by conversion from texture moving image data.

For example, image quality of a texture moving image includes a photo style, exposure, a dynamic range, and the like according to a hue and atmosphere desired to be reflected on the subject model 12 by the user, in addition to the resolution described above. Alternatively, the controller 180 of the digital camera 100 may set image quality of a texture moving image by image recognition for an attribute of the subject 11, a shooting environment, and the like.

For example, from the viewpoint of facilitating alignment processing and feature point extraction processing in the modeling processing, a gamma curve of log shooting may be applied to an alignment moving image in order to ensure a large dynamic range. Further, a photo style for facilitating the above processing may be set to an alignment moving image. For example, the controller 180 may perform image quality setting such as a photo style for emphasizing a feature point by image recognition of albedo information such as a reflectance and a normal direction of the subject 11.

A texture moving image and an alignment moving image are managed in association with each other for each frame at a predetermined frame rate (e.g., 30 fps), for example. A frame rate of each moving image is not particularly limited, and may be e.g. 1 fps (frame per second). The respective moving image data includes meta information indicating various states during shooting.

### 2-2. Shooting Guide Processing

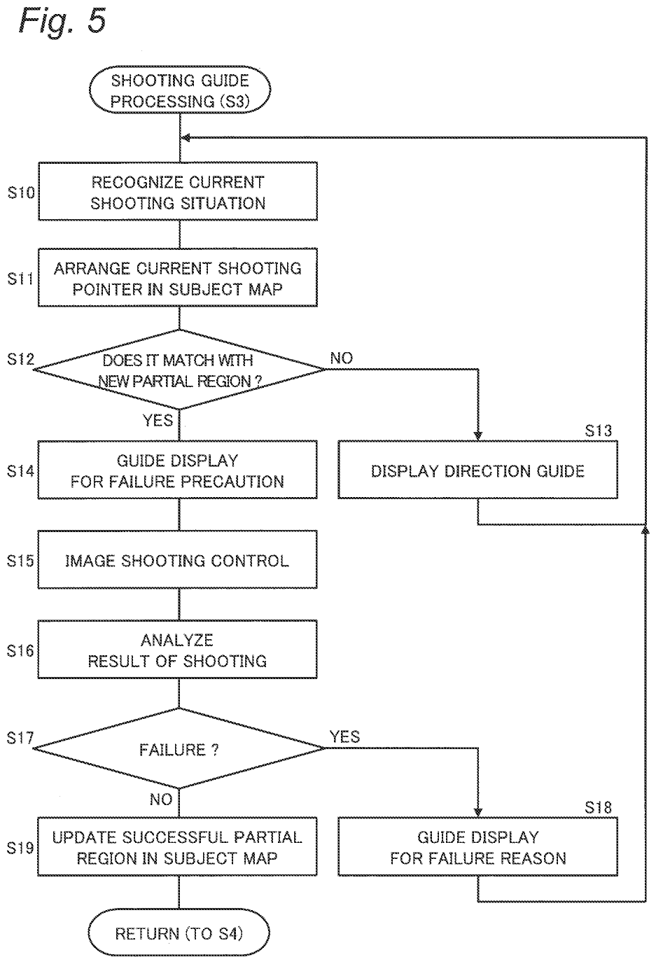

Details of the shooting guide processing in Step S3 of FIG. 3 will be described with reference to FIGS. 5 to 7C.

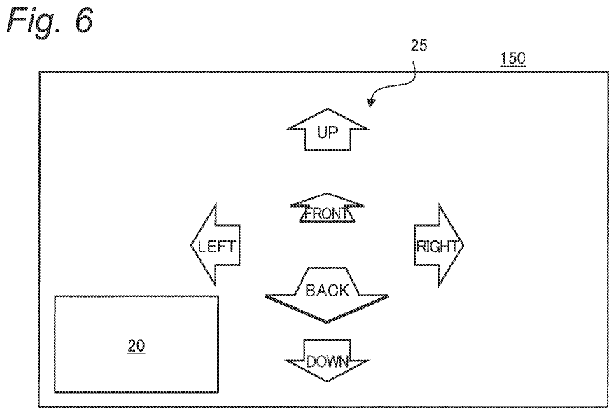

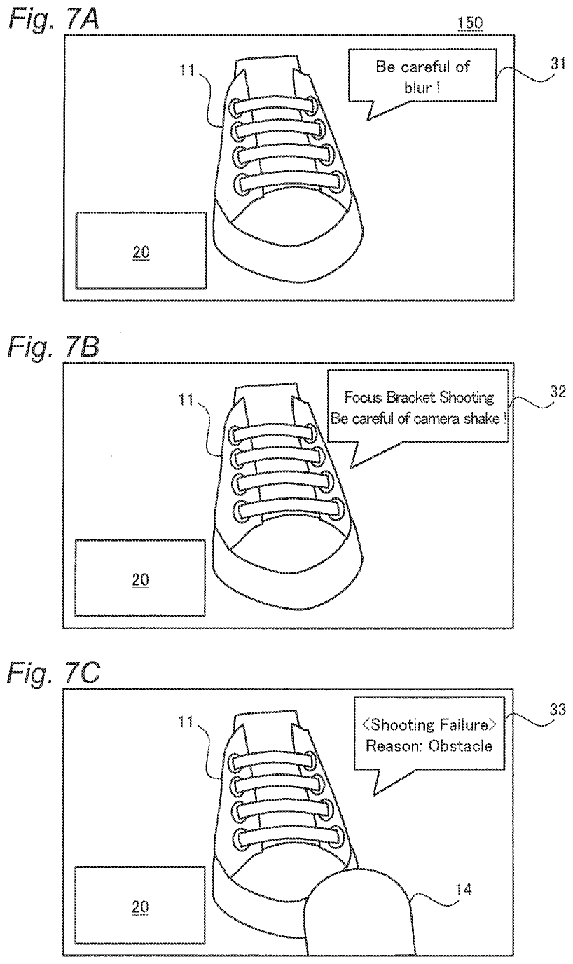

FIG. 5 is a flowchart exemplifying the shooting guide processing by the digital camera 100. FIG. 6 is a diagram for explaining a direction guide in the shooting guide processing. FIGS. 7A to 7C are diagrams illustrating a display example in the shooting guide processing.

First, the controller 180 recognizes a current shooting situation on the basis of various pieces of information detected by the digital camera 100 such as an image being shot in the scan shooting operation (S10). For example, the shooting situation includes a positional relation such as a position, a distance, and a direction of the digital camera 100 with respect to the subject 11. The shooting situation may include a state such as illumination in a shooting environment, or may include various internal states such as shooting setting of the digital camera 100.

In Step S10, the controller 180 analyzes self-position estimation such as simultaneous localization and mapping (SLAM) by image recognition, for example. At this time, the controller 180 may calculate a movement amount of a shooting position by using a detection result of the acceleration sensor 230 in the digital camera 100, or may calculate a change amount in a shooting direction by using a detection result of the gyro sensor 250. Furthermore, the controller 180 may recognize an illumination state of a shooting environment by a photometric method on an image or a photometric sensor. The controller 180 may manage a recognized illumination state and exposure setting in the digital camera 100 in association with each other.

The controller 180 arranges the shooting pointer 21 having a current positional relation in the subject map 20 on the basis of information of the recognized shooting situation (S11). For example, the controller 180 controls a position of the shooting pointer 21 in the subject map 20 so as to reflect a current shooting position and a shooting direction.

In Step S11, the controller 180 controls size of the shooting pointer 21 according to the current shooting distance in a manner that the size is enlarged more as the distance is shorter (see FIGS. 4A and 4B). Size of the shooting pointer 21 may be enlarged/reduced according to zooming in/out of an optical zoom or high/low resolution of an image being shot. For example, a shooting distance indicated by the shooting pointer 21 is measured as a substantial distance from a position on the subject 11 corresponding to a position of the shooting pointer 21 on the subject map 20 to a shooting position of the digital camera 100.

The controller 180 determines whether or not the arranged shooting pointer 21 matches with a new one of the partial regions 22 for which shooting is not succeeded yet in the subject map 20 (S12). For example, the determination in Step S12 is YES in a case where a position and size of the shooting pointer 21 are the same as a position and size of one of the partial regions 22 that is yet to be shot, and is NO otherwise. An allowable range may be appropriately used for the determination in Step S12.

When determining that the shooting pointer 21 does not match a new one of the partial regions 22 in the subject map 20 (NO in S12), the controller 180 displays a direction guide on the display monitor 150, for example (S13). After the above, the controller 180 performs the processing in and after Step S10 again. The direction guide in Step S13 will be described with reference to FIG. 6.

In the example of FIG. 6, a direction guide 25 is selectively displayed from a plurality of predetermined directions such as upper, lower, left, right, front, and back directions. The direction guide 25 is an example of the shooting guide information for guiding the user to adjust a positional relation of the digital camera 100 with respect to the subject 11. In Step S13, the controller 180 displays the direction guide 25 for a direction for guiding in a manner superimposed on a live view image (not illustrated in FIG. 6) on the display monitor 150, for example.

For example, in a case where a position of the shooting pointer 21 is shifted from the partial region 22 that is yet to be shot in the subject map 20 (NO in S12), the controller 180 displays the direction guide 25 in a direction toward the partial region 22 that is yet to be shot among upper, lower, left, right, front, and back directions (S13). In this way, the user can be guided to align the digital camera 100 with the partial region 22 that is yet to be shot in the subject map 20.

In a case where size of the shooting pointer 21 is different from size of the partial region 22 in the subject map 20 (NO in S12), the controller 180 displays the direction guide 25 in a direction in which size of the shooting pointer 21 becomes closer to size of the partial region 22 in a front-back direction (S13). In this way, it is possible to perform guidance for matching a shooting distance for each of the partial regions 22 in the subject map 20.

For example, when determining that the shooting pointer 21 matches a new one of the partial regions 22 (YES in S12), the controller 180 of the present embodiment performs various processing for accurate shooting for the partial region 22 (S14 to S18). For example, according to the recognized current shooting situation (S11), the controller 180 performs guide display for notifying the user of precautions causing failure of image shooting (S14). A display example in Step S14 is illustrated in FIG. 7A.

FIG. 7A illustrates an example in which image shooting of the subject 11 is performed from a direction different from that in FIG. 4A. In the present example, as image shooting is performed from a longitudinal direction of the subject 11, a case where blurring is likely to occur in a subject image is assumed, for example. In such a case, as exemplified in FIG. 7A, when recognizing a shooting situation from a specific imaging direction, the controller 180 of the present embodiment causes the display monitor 150 to display a message 31 for urging the user to call attention to blurring (S14).

With such guide display of the digital camera 100 (S14), the user can easily avoid such a shooting failure in a shooting situation in which a specific type of shooting failure is predicted to be likely to occur. The guide display in Step S14 is appropriately omitted depending on a shooting situation. Note that, in the present embodiment, image shooting of the partial region 22 is performed such that a portion outside the partial region 22 in the subject 11 is included in an angle of view, e.g. from the viewpoint of accuracy of alignment processing.

Furthermore, the controller 180 performs various control for image shooting of the partial region 22 (S15). For example, the shooting control in Step S15 includes focus control, exposure control, and the like, and is dynamically performed from the viewpoint of successful image shooting of the partial region 22 this time in a current shooting situation.

For example, in Step S15, in a shooting situation in which blurring is presumed to occur in another part when a part of the subject 11 is focused, shooting for synthesizing an image focused on the entire subject 11, that is, focus bracket shooting control may be executed. For a variation of guide display in such a case, a variation displayed in Step S14 instead of FIG. 7A is exemplified in FIG. 7B.

For example, the controller 180 controls the lens driver 120 so as to sequentially move a position of a focus lens in the optical system 110 for each frame of a moving image being shot (S15). According to such focus bracket shooting, a camera shake is predicted to be likely to become a cause of shooting failure in exchange for reduction in possibility of shooting failure due to blurring. In view of the above, in such a case, the controller 180 displays a message 32 for urging the user to call attention to a camera shake as illustrated in FIG. 7B, e.g., instead of the message 31 in FIG. 7A by recognizing the shooting situation as described above (S14).

For example, the user of the digital camera 100 can easily succeed in image shooting of a corresponding one of the partial regions 22 by holding a positional relation between the digital camera 100 and the subject 11 while paying attention to the guide display of Step S14 in the image shooting of Step S15. The controller 180 analyzes accuracy of an image as a result of such shooting (S16).

For example, in Step S16, the controller 180 detects the presence or absence of blurring, image blurring, blown-out highlights, black crushing, an obstacle, and the like in an image being shot as a failure factor. The processing of Step S16 is performed by image analysis for various viewpoints in which failure in image shooting occurs, and analysis of various state information such as detection information of the various sensors 230 and 250, focus position information, and camera shake correction information during shooting.

By analysis of a result of the shooting (S16), the controller 180 determines whether or not image shooting this time fails (S17). For example, the controller 180 proceeds to YES in Step S17 in a case where one or more failure factors are detected, and proceeds to NO in a case where none of the failure factors is detected.

When determining that the image shooting this time fails (YES in S17), the controller 180 performs guide display for notifying a reason of the shooting failure (S18). A display example of Step S18 is exemplified in FIG. 7C.

FIG. 7C illustrates an example in which image shooting fails due to an obstacle 14. A case where an image in which the obstacle 14 that shields a part or the whole of the subject 11 is reflected lowers accuracy of the modeling processing of the subject 11 can be considered. In view of the above, as exemplified in FIG. 7C, the controller 180 detects the obstacle 14 in an image being shot as a failure factor (YES in S16 and S17), and causes the display monitor 150 to display a message 33 indicating that shooting fails due to the presence of the obstacle 14 (S18). For example, after the notification of a failure reason (S18), the controller 180 returns to Step S10.

On the other hand, when determining that the image shooting this time does not fail (NO in S17), the controller 180 determines that the image shooting this time is successful and updates the subject map 20 and the like (S19). For example, the controller 180 changes the partial region 22, which is a target of the image shooting this time in the subject map 20, to a display mode of being already shot.

For example, in Step S19, the controller 180 switches a shooting success flag for the partial region 22 from an initial value “OFF” to “ON”. For example, the shooting success flag manages whether or not image shooting is successful for each of the partial regions 22 in the subject map 20 on the basis of “ON/OFF”, and is stored in the buffer memory 170, for example.

After the update based on a result of successful shooting (S19), the controller 180 ends the shooting guide processing (S3 in FIG. 3), and proceeds to Step S4. For example, the controller 180 records various information obtained in the shooting guide processing in association with each frame as meta information in each piece of moving image data shot in parallel with the shooting guide processing (S3).

According to the shooting guide processing (S3) described above, the digital camera 100 of the present embodiment can present various pieces of the shooting guide information such as the subject map 20 and the various messages 31 to 33 to the user to guide the user to be successful in image shooting (S13, S14, and S18).

In Step S10 described above, recognition of an imaging situation is not limited to be performed by use of each of the sensors 230 and 250 provided in the digital camera 100, and various sensor devices externally connected to the digital camera 100 may be used. For example, the controller 180 may analyze SLAM by using a sensor device such as Lidar. Various subject tracking methods in the digital camera 100 may be used for the image recognition in Step S10, and for example, space recognition based on depth of defocus (DFD) and motion vector analysis may be performed.

The guide display in Step S13 is not particularly limited to the direction guide 25, and may be message display, for example. The guide display in Steps S14 and S18 is not particularly limited to the messages 31 to 33, and may be display of various icons or the like, for example.

For example, the processing of Step S14 can be performed by identifying in advance a shooting situation in which various shooting failures are likely to occur, and storing information of such a prediction result in a place that can be referred to by the controller 180 such as the flash memory 240 of the digital camera 100. For example, the controller 180 refers to the information of the prediction result described above at the time of executing the scan shooting operation, and in a case where the current shooting situation (S11) corresponds to a specific shooting situation, performs guide display for calling attention regarding a shooting failure of a corresponding type (S14). Such a shooting situation may include various shooting control in Step S15.

In Step S15, when a change in an illumination state of a shooting environment is recognized, the controller 180 may change exposure setting so that exposure conditions are equalized between image shootings for the partial regions 22. For example, in a case where a shutter speed is changed to a low speed in order to offset a change in which illumination becomes bright, there is likely to be influence of a camera shake. Therefore, the controller 180 performs guide display for calling attention to a camera shake (S14). In a case where a change of bringing an aperture value close to an open value is made according to a change in an illumination state similar to the above, the depth of field becomes shallow, and thus the controller 180 performs guide display for calling attention to blurring (S14).

In Step S15, the controller 180 may perform control for changing image quality of a moving image. For example, resolution may be changed according to a shooting distance, or a photo style may be changed according to information (i.e., albedo information) indicating a manner of light reflection such as a reflectance of the subject 11. Such setting change may be performed in a manner that a change is continuously made in a moving image. For example, the controller 180 may manage change content of image quality for each frame of a moving image being shot, and perform image processing for actually changing image quality afterwards. Such setting change of image quality may be performed on one of a texture moving image and an alignment moving image, or may be performed on both of them.

### 2-3. Thinning Storage Processing

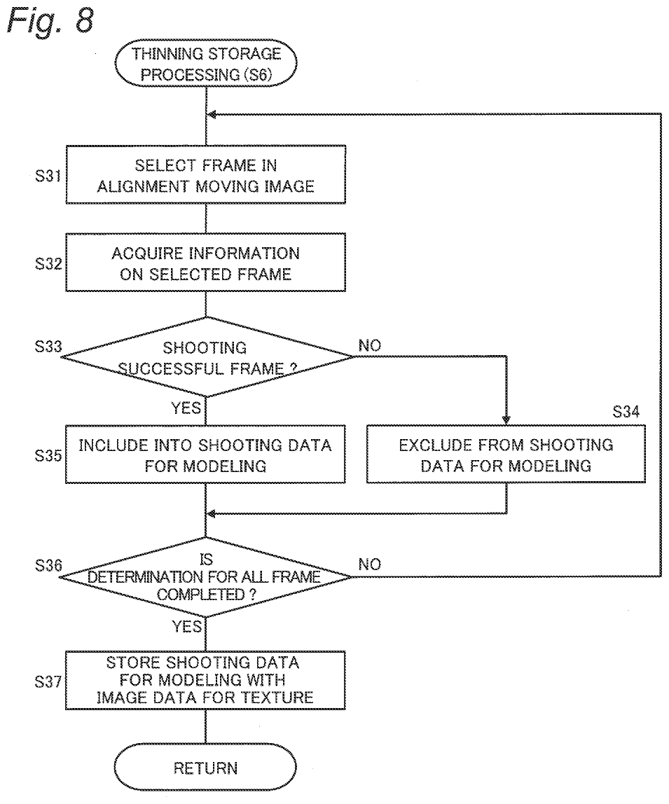

The thinning storage processing in Step S6 of FIG. 3 will be described with reference to FIG. 8.

FIG. 8 is a flowchart exemplifying the thinning storage processing in the digital camera 100. Hereinafter, an example in which the thinning storage processing (S6) is executed by the controller 180 of the digital camera 100 after moving image shooting is finished in the scan shooting operation (S5) will be described.

First, the controller 180 sequentially selects each frame in alignment moving image data as a determination target for thinning, for example (S31). For example, the controller 180 cuts out a frame to be determined from alignment moving image data as a still image and holds the frame in the buffer memory 170.

The controller 180 acquires information regarding success or failure of image shooting of the selected determination target frame (S32). For example, the controller 180 refers to a shooting success flag recorded in the buffer memory 170 at the time of the scan shooting operation.

The processing in Step S32 may be performed by image analysis of the cut-out still image and analysis of meta information. For example, the controller 180 analyzes a positional relation with respect to the subject 11 at the time of shooting or detects a failure factor of shooting in an image by self-position estimation of the determination target frame. Such processing may be performed similarly to Steps S10 and S16 in the scan shooting operation (FIG. 5), or a determination result similar to Step S17 may be obtained afterwards.

Next, on the basis of the information acquired in Step S32, the controller 180 determines whether or not the selected frame is a frame in which image shooting reaches success in a predetermined positional relation useful for the modeling processing (S33). The determination in Step S33 is YES in a case where the shooting success flag is ON, and is NO in a case where the shooting success flag is OFF. For example, the predetermined positional relation is a positional relation corresponding to each of the partial regions 22 in the subject map 20 (FIG. 4), and is defined at intervals between a plurality of shooting positions at a common shooting distance.

In a case of determining that the selected frame is not a frame of successful shooting (NO in S33), the controller 180 determines to exclude the frame from shooting data for modeling, and deletes the frame from the buffer memory 170, for example (S34).

On the other hand, in a case of determining that the selected frame is a frame of successful shooting (YES in S33), the controller 180 determines to include the selected frame in shooting data for modeling, and stores the selected frame in the memory card 200 as image data for alignment, for example (S35).

For example, shooting data for modeling includes image data for alignment and image data for texture, and further includes meta information regarding each piece of image data. Each piece of image data is, for example, still image data. For example, in Step S35, the controller 180 stores, as meta information of a corresponding frame, various shooting situations of image shooting, for example, a state of illumination and various shooting settings of the digital camera 100. In a case where focus bracket shooting is performed in the scan shooting operation, the controller 180 may perform depth synthesis processing for a plurality of frames corresponding to one time of the shooting, and store synthesized image data of one frame.

For example, the controller 180 determines whether or not the above determination processing (S31 to S35) is performed on all frames in an alignment moving image (S36). In a case where the determination on all frames is not completed (NO in S36), the controller 180 newly selects a frame that is yet to be a determination target (S31), and performs the processing in and after Step S32 again. In this way, as the processing of Steps S31 to S36 is repeated, an unnecessary frame can be automatically thinned out from alignment moving image data.

When the determination is completed for all frames (YES in S36), the controller 180 extracts image data for texture as a result of thinning of a texture moving image similarly to image data for alignment, and includes the image data for texture in shooting data for modeling (S37). Specifically, in a texture moving image, the controller 180 selectively records a frame corresponding to the frame of the image data for alignment (S35) in, for example, the memory card 200 as image data for texture. In this way, image data for texture does not include a frame corresponding to the frame excluded in Step S34 in a texture moving image.

After the shooting data for modeling is stored (S37), the controller 180 ends the thinning storage processing (Step S6 in FIG. 3).

According to the thinning storage processing (S6) described above, shooting data for modeling can be limited to a frame reaching successful shooting in an appropriate positional relation from each piece of moving image data shot in the scan shooting operation (S33 to S35).

For example, it is possible to reduce a load on modeling processing by thinning out a frame of an overlapping positional relation for each of the partial regions 22 in the subject map 20. Furthermore, the number of frames of successful shooting to be left as shooting data for modeling can be set according to the number of the partial regions 22 of the subject map 20. As accuracy of reproducing a three-dimensional shape of the subject model 12 may be deteriorated in a frame of shooting failure having blur, a camera shake, an obstacle, and the like, the accuracy of the modeling processing can be improved by thinning out such a frame.

By thinning out a texture moving image using a thinning result of an alignment moving image as in the above thinning storage processing (S6), it is possible to reduce a processing load on the thinning storage processing (S6) due to high image quality of texture moving image data, for example. The digital camera 100 according to the present embodiment is not limited to the above thinning storage processing (S6), and may perform determination processing for thinning from a texture moving image, for example.

The thinning storage processing (S6) as described above may be performed simultaneously in parallel with the moving image shooting (S2 to S5) of the scan shooting operation. Alternatively, the thinning storage processing (S6) may be performed afterwards or may be performed outside the digital camera 100 (e.g., the image editing PC 200). In this case, moving image data shot in the scan shooting operation is recorded in the memory card 200.

According to shooting data for modeling obtained by the above-described thinning storage processing (S6), when the image editing PC 200 executes the modeling processing, correction of a shooting parameter can be optimized among pieces of image data of a plurality of frames with reference to meta information on a shooting situation, for example. For example, the image editing PC 200 grasps a situation where there is a change in a shooting environment such as an illumination state at the time of shooting or the digital camera 100 changes settings such as exposure between pieces of image data for alignment when alignment processing is executed, and optimizes a correction value of various shooting settings. In this way, accuracy of the modeling processing can be improved by use of meta information of a shooting situation in shooting data for modeling.

### 3. Summary

As described above, the digital camera 100 according to the present embodiment is an example of an imaging apparatus that causes the user to perform image shooting for modeling of the subject 11. The digital camera 100 includes the image sensor 140 as an example of an image sensor, the display monitor 150 as an example of an output interface, and the controller 180. The image sensor 140 images the subject 11 and generates image data. The output interface outputs information to a user. The controller 180 recognizes a situation in which the scan shooting operation as an example of image shooting operation including a plurality of times of imaging by the image sensor 140 for modeling of the subject 11 is executed by the digital camera 100 (S10), and controls the output interface (S3). The controller 180 causes the output interface to output the shooting guide information (20, and 31 to 33) for guiding the user to succeed in shooting each of a plurality of images for modeling of the subject 11 according to a situation recognized in the scan shooting operation (S11, S13, S14, and S18).

According to the digital camera 100 described above, image shooting that facilitates modeling of the subject 11 can be performed by guiding the user with the shooting guide information to succeed in a plurality of times of image shooting in the scan shooting operation.

In the digital camera 100 of the present embodiment, the shooting guide information includes the subject map 20 as an example of map information indicating each of a region where image shooting for modeling is successful and a region where image shooting for modeling is not successful in the partial region 22 as an example of a plurality of regions corresponding to a plurality of images for modeling of the subject 11. By the above, it is possible to guide the user to a portion to be shot in the subject 11 and to allow image shooting for modeling of the subject 11 to be performed easily.

In the digital camera 100 of the present embodiment, the partial region 22 in which image shooting is successful and the partial region 22 in which image shooting is not successful are arranged along a three-dimensional shape of the subject 11 in the subject map 20 (see FIG. 4B). By the above, a portion that is already shot and a portion that is yet to be shot are visualized along a three-dimensional shape of the subject 11, and image shooting for modeling of the subject 11 can be easily performed.

In the digital camera 100 of the present embodiment, the shooting guide information includes the shooting pointer 21 as an example of a pointer indicating a position corresponding to an image being shot by the user on the subject map 20 as an example of map information associated with the subject 11. By the above, a correspondence between the image being shot and the subject map 20 is visualized, and image shooting for modeling of the subject 11 can be easily performed. The shooting pointer 21 may indicate a position corresponding to an image being shot in map information associated with the subject 11 in various modes, without limitation to the above-described subject map 20.

In the digital camera 100 of the present embodiment, each of a plurality of the partial regions 22 in the subject map 20 has size indicating a predetermined distance. The controller 180 controls size of the shooting pointer 21 in accordance with a distance between the subject 11 and the digital camera 100 (S12). By the above, it is possible to perform guidance to set a shooting distance from the partial region 22 in the subject map 20 to be the same, and allow image shooting for modeling of the subject 11 to be performed easily.

In the digital camera 100 of the present embodiment, the controller 180 controls the shooting guide information so as to notify precautions causing failure of image shooting for modeling of the subject 11 according to a situation recognized in the scan shooting operation (S14). By the above, it is possible to guide the user to avoid shooting failure of the precautions, and to allow image shooting for modeling of the subject 11 to be performed easily.

In the digital camera 100 of the present embodiment, when image shooting for modeling of the subject 11 fails (YES in S17), the controller 180 controls the shooting guide information so as to notify a factor of failure of the image shooting (S18). By the above, when image shooting fails, a reason for the failure can be notified to the user, and it is possible to make subsequent image shooting likely to be successful.

In the digital camera 100 according to the present embodiment, the controller 180 generates shooting data for modeling as an example of shooting data including first and second images having mutually different image qualities as a result of the scan shooting operation (S2 to S6). Image quality for an image for alignment of an example of the second image is more suitable for information processing for modeling than image quality of an image for texture of an example of the first image. For example, an image for alignment has a lower resolution or a wider dynamic range than an image for texture. In this way, an image with image quality suitable for alignment processing and the like for modeling is obtained, so that the modeling processing can be easily performed.

In the digital camera 100 according to the present embodiment, the controller 180 removes a specific image from all images shot in the scan shooting operation (S34), and generates shooting data for modeling so as to indicate a remaining image (S31 to S37). The specific image includes at least one of an image in which image shooting for modeling of the subject 11 fails and an image overlapping with an image in which a positional relation between the subject 11 and the digital camera 100 remains at the time of shooting. By the above, unnecessary image data is omitted in the modeling processing, and shooting data for modeling in which useful image data is left is obtained, so that the modeling processing can be easily performed.

### Second Embodiment

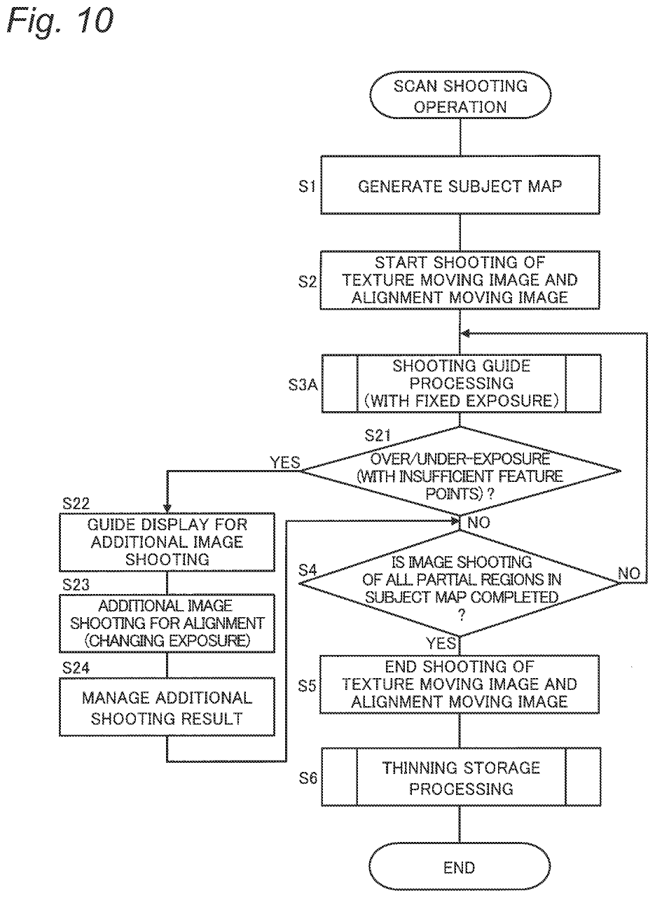

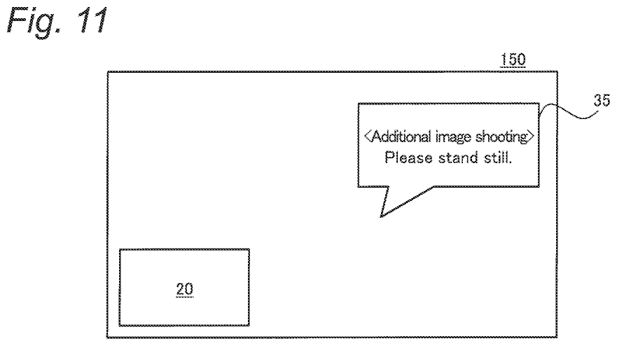

Hereinafter, a second embodiment of the present disclosure will be described with reference to FIGS. 10 to 11. In the first embodiment, the digital camera that simultaneously shoots an image for texture and an image for alignment is described. In the second embodiment, a digital camera that additionally shoots an image for alignment from an image for texture in a specific case will be described.

Hereinafter, description of a configuration and operation similar to those of the imaging system 10 and the digital camera 100 according to the first embodiment will be omitted as appropriate, and the imaging system 10 and the digital camera 100 according to the present embodiment will be described.

FIG. 10 is a flowchart exemplifying the scan shooting operation by the digital camera 100 according to the second embodiment. For example, the digital camera 100 of the present embodiment performs the scan shooting operation for modeling of a subject in the imaging system 10 as in the first embodiment.

In the scan shooting operation (FIG. 3) of the first embodiment, excessive or insufficient exposure such as blown-out highlights and black crushing is guided in the shooting guide processing (S3) as a failure factor of image shooting. Apart from the assumption of the first embodiment, in view of reality to reproduce an appearance of a modeling target including light and shade of the modeling target, advantage can be considered to use common exposure setting among a plurality of images for texture in different shooting directions. On the other hand, for an image for alignment, a case can be considered where feature points cannot be sufficiently obtained due to excessive or insufficient exposure, resulting in difficulty for alignment processing in subject modeling.

In view of the above, in the digital camera 100 of the present embodiment as exemplified in FIG. 10, when performing the scan shooting operation similar to that of the first embodiment, the controller 180 keeps a fixed exposure setting for texture in the shooting guide processing (S3A) for each partial region (see S4). Furthermore, in the scan shooting operation of the present embodiment, the controller 180 additionally performs image shooting processing with respect to excessive or insufficient exposure for alignment (S21 to S24). A portion of a subject indicated by each partial region is an example of a shooting portion to be a target of each time of image shooting in the present embodiment.

In the shooting guide processing (S3A) of the present embodiment, the controller 180 performs the processing (S10 to S19 in FIG. 5) similar to that of the first embodiment, for example, and performs shooting control using uniform exposure setting for texture (S15). Further, the controller 180 of the present embodiment analyzes a shooting result without including excessive or insufficient exposure in failure factors (S16), and detects whether image shooting of each time fails or succeeds similarly to the first embodiment (S17). The exposure setting for texture in Step S3A is an example of predetermined exposure setting in the present embodiment.

In the shooting guide processing (S3A) of the present embodiment, in an exemplary case where an image of a shooting result includes excessive or insufficient exposure but does not include a failure factor for a specific partial region, the shooting result is regarded as successful, to use it as an image for texture of the partial region (S19 in FIG. 5). By the above, reality of subject modeling as described above can be improved in a subject having a difference in brightness or the like, as an image for texture is dark in a dark portion and an image for texture is bright in a bright portion.

In the digital camera 100 of the present embodiment, the controller 180 determines, for example, whether or not excessive or insufficient exposure occurs in a shot image on the basis of the result of successful image shooting in Step S3A (S21). The determination in Step S21 is made in order to detect, from a plurality of shooting portions in the subject, a shooting portion that does not include a feature point for which alignment processing can be executed in the image of successful shooting in Step S3A.

In Step S21, for example, the controller 180 refers to luminance distribution in the image of successful shooting, and counts the number of pixels whose luminance is equal to or more than a predetermined upper limit value (e.g., “255”) or equal to or less than a predetermined lower limit value (e.g., “0”). Next, the controller 180 detects presence or absence of excessive or insufficient exposure according to whether or not the counted number of pixels is equal to or more than a predetermined threshold (S21).

For example, the above-described threshold is set according to a specified amount of feature points for which alignment processing can be executed, and indicates a reference in which feature points in an image are insufficient to an extent that it is difficult to execute alignment processing due to excessive or insufficient exposure. The specified amount of feature points corresponding to the threshold is an example of a predetermined amount in which the number of feature points in the present embodiment is an example of a feature amount. The feature amount of the present embodiment may be the number of pixels having luminance less than the upper limit value and exceeding the lower limit value in an image of successful shooting, or size of an image region having such luminance. A feature point can be extracted from an image region of such luminance distribution.

In a case of determining no excessive or insufficient exposure occurs (NO in S21), the controller 180 proceeds to Step S4 similarly to the case where an image of successful shooting is obtained in the first embodiment. In this way, in the scan shooting operation of the digital camera 100, an image for texture and an image for alignment are stored from a result of successful shooting for a corresponding shooting direction.

On the other hand, in a case of determining that exposure is excessive or insufficient (YES in S21), for example, the controller 180 performs display to guide the user to additional image shooting for a corresponding capture direction (S22). A display example of Step S22 is exemplified in FIG. 11.

FIG. 11 illustrates an example of the guide display (S22) in the digital camera 100 of the present embodiment. For example, the controller 180 causes a message 35 prompting the user to stand still in additional shooting to be displayed in a manner superimposed on a live view image (not illustrated in FIG. 11 as in FIG. 6) on the display monitor 150 (S22). The present message 35 may be displayed from the viewpoint of matching a shooting direction of an image for alignment shot in additional shooting with a shooting direction of an image for texture obtained as successful shooting immediately before. The present message 35 is an example of the shooting guide information in the present embodiment.

In the digital camera 100 of the present embodiment, the controller 180 executes additional shooting for alignment in a state where the guide display (S22) as described above is performed, for example (S23). For example, the controller 180 executes exposure bracket shooting for shooting, using exposure setting for texture as a reference, an image with underexposure setting in which an exposure value is decreased from the setting and an image with overexposure setting in which an exposure value is increased (S23). In Step S23, the controller 180 temporarily stops shooting (S2, S5, and the like) of a texture moving image or the like, for example.

The exposure setting for alignment in Step S23 is an example of additional exposure setting in the present embodiment. In the additional shooting in Step S23, the configuration is not limited to one in which both an image with the underexposure setting and an image with the overexposure setting are shot, and may be one in which either one of them is shot. For example, the controller 180 may shoot an image with the underexposure setting when blown-out highlights is detected in Step S21 immediately before, or may shoot an image with the overexposure setting when black crushing is detected (S23).

In Step S23, an exposure correction value for correcting an exposure value from exposure setting for texture to the underexposure/overexposure setting is set in advance from the viewpoint of eliminating presumed blown-out highlights/black crushing, for example. Alternatively, the controller 180 may dynamically set an exposure correction value from the recognition result of a current shooting situation (S10 in FIG. 5). A plurality of exposure correction values may be used, and for example, the controller 180 may perform image shooting with the underexposure/overexposure setting a plurality of times (S23).

Next, on the basis of image data as a result of the additional shooting in Step S23, the controller 180 manages an image for alignment in association with an image for texture of successful shooting in preceding Step S3A (S24), and proceeds to Step S4. For example, the controller 180 records management information for managing a last frame of a temporarily stopped texture moving image as an image for texture corresponding to an image for alignment by additional shooting in the buffer memory 170 or the flash memory 240 (S24).

The management in Step S24 may be performed by including information for identifying a corresponding image for texture in meta information of image data obtained in the additional shooting (S23). In a case where images of a plurality of frames are obtained in the additional shooting (S23), the images of a plurality of frames may be managed as an image for alignment corresponding to an image for texture in one frame common to each other. Alternatively, the controller 180 may synthesize images of a plurality of frames so as to expand a dynamic range to generate a high dynamic resolution (HDR) image and manage the image as an image for alignment of one frame. Such an image frame for alignment may be subsequently inserted into an alignment moving image.

According to operation of the digital camera 100 of the present embodiment described above, while exposure setting for texture is maintained in various shooting directions (S3A), in the shooting direction in which excessive or insufficient exposure occurs (YES in S21), additional image shooting is performed by changing exposure setting to that for alignment (S23). By the above, reality in an image for texture can be improved, alignment processing can be performed with high accuracy, and subject modeling can be performed easily.

In the above description, an example in which the controller 180 determines excessive or insufficient exposure without calculating a feature point when detecting a specific shooting portion in which a sufficient feature point is not included in the image of successful shooting (S3A) in Step S21 is described. The digital camera 100 of the present embodiment is not limited to this, and the controller 180 may calculate a feature point included in an image of successful shooting in Step S21. In this way, the controller 180 may detect a specific shooting portion by comparing and determining the calculated number of feature points with a predetermined amount (S21). In this case, a processing load on the digital camera 100 can be reduced as much as calculation of a feature point not performed on an image of shooting failure.

In the above description, the message 35 in FIG. 11 is exemplified as an example of the guide display (S22) for additional shooting, but Step S22 is not particularly limited to this. For example, in Step S22, the controller 180 may perform icon display on the display monitor 150 as shooting guide information for additional shooting, or may perform highlight display of a corresponding partial region on a subject map. The shooting guide information for additional shooting is not limited to monitor display, and may be audio output or the like.

In the digital camera 100 of the present embodiment, the shooting guide information for additional shooting may be omitted. For example, when detecting the specific shooting portion (YES in S21), the controller 180 may perform image shooting for alignment without particularly performing the processing in Step S22 (S23).

In the digital camera 100 according to the present embodiment, guidance for successful image shooting may be performed as in the first embodiment also in the additional image shooting (S23). For example, in Step S23, the controller 180 may perform guide display and the like similar to that Steps S13 and S18 in the shooting guide processing (S3) of FIG. 5.

The above-described processing for additional shooting (S21 to S24) may be performed in the shooting guide processing (S3A) in the present embodiment. For example, a subject map or the like may be updated (S19 in FIG. 5) after the processing in Steps S21 to S24 is performed.

As described above, in the digital camera 100 according to the present embodiment, the scan shooting operation as an example of image shooting operation includes a plurality of times of imaging with exposure setting for texture as an example of predetermined shooting setting for a plurality of shooting portions in a subject. The controller 180 controls the image shooting operation so as to perform, in addition to image shooting with the predetermined shooting setting for the specific shooting portion among a plurality of shooting portions (YES in S21), image shooting with shooting setting for alignment as an example of additional shooting setting different from predetermined shooting setting (S22 to S24). The specific shooting portion has a feature amount for modeling that is less than a predetermined value in an image shot with the predetermined shooting setting.

According to the digital camera 100 described above, the scan shooting operation is performed so as to perform image shooting with additional shooting setting for a specific shooting portion in which a feature amount for modeling is less than a predetermined value with predetermined shooting setting. By the above, the digital camera 100 according to the present embodiment can easily secure a feature amount in an image of each shooting portion in the scan shooting operation, and can perform image shooting that facilitates subject modeling.

In the digital camera 100 of the present embodiment, the controller 180 may detect a specific shooting portion on the basis of an image shot with predetermined shooting setting (S21), and perform image shooting with additional shooting setting for the detected specific shooting portion (S22). For example, the additional shooting setting is setting in which a feature amount for modeling in an image in which a specific shooting portion is shot is larger than that in a case where shooting is performed with predetermined shooting setting.

In the digital camera 100 of the present embodiment, each shooting setting includes exposure setting, for example. For example, in a case where a feature point is insufficient due to blown-out highlights in predetermined shooting setting, additional shooting setting has an exposure value smaller than an exposure value of the predetermined shooting setting. In a case where a feature point is insufficient due to black crushing in predetermined shooting setting, additional shooting setting has an exposure value larger than an exposure value of the predetermined shooting setting. For example, additional shooting setting is set such that a feature amount is equal to or more than a predetermined value.

In the digital camera 100 of the present embodiment, the controller 180 controls the shooting guide information so as to instruct the user to stand still for image shooting with additional shooting setting (S22). By the above, it is easy for the user to succeed in additional image shooting for a specific shooting portion, and image shooting for subject modeling can be performed easily.

In the digital camera 100 according to the present embodiment, for a shooting portion other than a specific shooting portion among a plurality of shooting portions (NO in S21), the controller 180 controls the image shooting operation so as not to perform image shooting with the additional shooting setting but to perform image shooting with predetermined shooting setting (S3A). By the above, it is possible to improve reality of an image for texture, for example, by using common shooting setting for a shooting portion other than a specific shooting portion, and image shooting for subject modeling can be performed easily.

In the digital camera 100 of the present embodiment, the controller 180 detects failure or success in image shooting due to predetermined shooting setting for each shooting portion in the scan shooting operation (S3A and S17). In a case where failure of image shooting is detected (YES in S17), the controller 180 controls the image shooting operation so as to perform image shooting with predetermined shooting setting again for the shooting portion (S18 to S15). In a case where success of the image shooting is detected (NO in S17), when the shooting portion is a specific shooting portion (YES in S21), the controller 180 controls the image shooting operation so as to perform image shooting with additional image shooting setting in addition to the image shooting with the predetermined image shooting setting (S22 to S24).

According to the digital camera 100 of the present embodiment, image shooting for subject modeling can be performed easily by additional image shooting for a specific shooting portion separately from image shooting performed again with predetermined image shooting setting when image shooting fails.

In the digital camera 100 of the present embodiment, for the shooting portion other than the specific shooting portion among a plurality of shooting portions (NO in S21), the controller 180 controls the image shooting operation so as to shoot an image for texture and an image for alignment as an example of the first and second images having mutually different image qualities with predetermined shooting setting (S3A to S4). For the specific shooting portion (YES in S21), the controller 180 controls the image shooting operation such that the first image is shot with the predetermined shooting setting and the second image is shot with the additional shooting setting (S3A, S22 to S24).

According to the digital camera 100 of the present embodiment, when first and second image shooting is performed at the same time, in a specific case, the second image shooting is additionally performed from the first image shooting, shooting accuracy of each can be secured, and image shooting for subject modeling can be performed easily.

In the above description, the exposure setting is described as an example of shooting setting. The shooting setting of the present embodiment is not limited to this, and may be setting in other image shooting, e.g. setting of a polarization state. For example, in a case where a subject has metallic luster, an image for texture may include blown-out highlights of metallic luster or the like from the viewpoint of reproducing metallic luster, but a feature point may be insufficient in an image for alignment. In view of the above, as it is known that reflected light on a metal surface is biased in a specific polarization direction, the digital camera 100 of the present embodiment may perform the scan shooting operation so as to change a polarization state in additional image shooting.

In the present embodiment, the digital camera 100 may incorporate a polarizing filter such as a circular polarized (CPL) filter, or a polarizing filter may be used externally to the digital camera 100. For example, shooting setting for alignment is set to a polarization state farther from a polarization direction of reflected light of a metal surface than that for shooting setting for texture. In the scan shooting operation of the present embodiment, for example, when metallic luster is detected by image analysis or the like in place of or in addition to Step S21, the controller 180 controls the display monitor 150 to instruct the user to change a polarization state in the guide display for additional shooting (S22).

Alternatively, in the digital camera 100 of the present embodiment, in a case where a polarization state of a polarizing filter can be automatically controlled, the controller 180 changes a polarization state from that for texture to that for alignment instead of the above instruction to the user, and performs additional shooting (S23). By the above, in the digital camera 100 of the present embodiment, for alignment, it is possible to obtain an image in which blown-out highlights or the like of metallic luster is reduced and a feature point can be easily secured. As described above, the digital camera 100 according to the present embodiment may include at least one of exposure setting and polarization state setting.

### Other Embodiments

As described above, the first and second embodiments are described as an example of the technique disclosed in the present application. However, the technology in the present disclosure is not limited to this, and is applicable to embodiments in which changes, replacements, additions, omissions, and the like are appropriately made. In addition, it is also possible to combine each component described in each of the above-described embodiments to form a new embodiment.

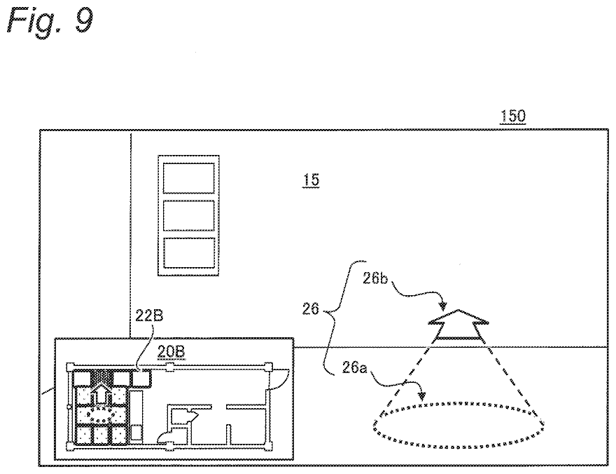

In the first embodiment, the case where the subject 11 is an object is described (see FIG. 1), but a subject of the present system 10 is not limited to an object. The subject map 20 of the first embodiment is created by automatic recognition of a subject attribute by the digital camera 100 or user setting, but the method of creating the subject map 20 is not particularly limited to this. Such a variation will be described with reference to FIG. 9.

FIG. 9 exemplifies various shooting guide information in a variation of the imaging system 10. In the present variation, the controller 180 of the digital camera 100 causes the display monitor 150 to display the various shooting guide information such as a subject map 20B and a shooting guide 26 in superimposition on a live view image of a subject 15.

In the present system 10, the subject 15 as a target of modeling may be a landscape such as a room, as exemplified in FIG. 9. For example, as a subject attribute of the setting menu described above, there may be a landscape in addition to an attribute of various objects, and for example, options such as a room, a town, or a park may be provided in an attribute of a landscape.

In the example of FIG. 9, the subject map 20B regarding the subject 15 is based on shape data of the subject 15 such as a room layout. For example, the digital camera 100 of the present embodiment can easily create the subject map 20B by acquiring shape data indicating a diagram or a three-dimensional shape of the subject 15 from the outside. Such shape data of the subject 15 may be utilized for modeling processing. For example, modeling of the subject 15 can be performed by simple processing of arranging texture data at an appropriate position in the shape data. Such a method of using shape data is not particularly limited to the subject 15 of a landscape, and is also applicable to the subject 11 of an article.

In the example of FIG. 9, the controller 180 performs the scan shooting operation similar to that of the first embodiment by using the shooting guide 26 instead of the direction guide 25 of the first embodiment, for example. The shooting guide 26 includes a position guide 26a and a direction guide 26b. The position guide 26a indicates a shooting position where the user of the digital camera 100 should be located in the subject 15. The direction guide 26b indicates a direction in which shooting should be performed from a shooting position of the position guide 26a. The digital camera 100 according to the present embodiment can guide a positional relation in which image shooting should be performed for each partial region 22B in the subject map 20B while the user moves in the subject 15 by the shooting guide 26.

In the above embodiments, the scan shooting operation of moving image shooting is described as the image shooting operation for modeling of a subject in the digital camera 100, but the image shooting operation is not limited to moving image shooting and may be still image shooting. For example, the digital camera 100 according to the present embodiment may perform the scan shooting operation similar to that of the first embodiment by continuous shooting instead of moving image shooting. The digital camera 100 according to the present embodiment may perform the image shooting operation in which moving image shooting and still image shooting are combined. For example, the digital camera 100 according to the present embodiment may temporarily stop moving image shooting at the time of control of focus bracket shooting of the first embodiment, shift to still image shooting, and acquire a depth synthesis image. The digital camera 100 according to the present embodiment may acquire a super-resolution synthesis image and an HDR image instead of a depth synthesis image according to a shooting situation.

In the above embodiments, the imaging system 10 in which the modeling processing is performed by the image editing PC 200 is described, but the modeling processing may be performed by various information processing apparatuses without limitation to the image editing PC 200. The digital camera 100 may transmit shooting data for modeling to an external server device such as a cloud server via the communication module 260, and the server device may execute the modeling processing on the basis of the shooting data received from the digital camera 100. Alternatively, the controller 180 of the digital camera 100 may perform the modeling processing on the basis of shooting data for modeling.

In the above-described embodiments, various recognition processing or analysis processing executed by the controller 180 of the digital camera 100 may also be executed by an external server device or the like, similarly to the above-described modeling processing. For example, the controller 180 of the digital camera 100 may execute Step S1 of the scan shooting operation (FIG. 3), Steps S10 and S16 of the shooting guide processing (FIG. 5), Step S32 of the thinning storage processing (FIG. 8), or the like by transmitting and receiving data to and from an external server device.

In the above embodiments, the display monitor 150 is exemplified as an example of the output interface (display) of the digital camera 100. In the digital camera 100 of the present embodiment, the output interface is not limited to the display monitor 150, and may be e.g. a display such as an electronic view finder (EVF), an output module that outputs a video signal according to the HDMI (registered trademark) standard, or the like. Further, the output interface of the present embodiment may be an interface circuit of various external display devices, and for example, a display device of augmented reality (AR), virtual reality (VR), or the like may be used.

In the above embodiments, the example in which the shooting guide information is displayed on the display monitor 150 is described, but output of the shooting guide information is not limited to this. In addition to or in place of displaying the shooting guide information, the digital camera 100 of the present embodiment may output various shooting guide information by voice using the speaker 280, for example. Voice output of the shooting guide information may be utterance output or a predetermined sound effect such as an alarm sound.

In the above embodiments, the digital camera 100 including the optical system 110 and the lens driver 120 is illustrated. The imaging apparatus of the present embodiment does not need to include the optical system 110 or the lens driver 120, and may be an interchangeable lens type camera, for example.

In the above embodiments, a digital camera is described as an example of an imaging apparatus, but the present disclosure is not limited to this. The imaging apparatus of the present disclosure has only to be an electronic apparatus having an image shooting function (e.g., a video camera, a smartphone, a tablet terminal, or the like).

Further, an application field of the present system 10 is not particularly limited to E-commerce, and can be applied to modeling of various subjects. The present system is useful in various applications where reality is required for reproducing a subject, such as digitization of a preview of real estate.

### Summary of Aspects

Hereinafter, various aspects according to the present disclosure will be added.

A first aspect according to the present disclosure is an imaging apparatus for causing the user to perform image shooting for modeling of a subject. The imaging apparatus includes an image sensor that capture an image of a subject to generate image data, an output interface that outputs information to the user, and a controller that recognizes a situation in which image shooting operation is executed by the imaging apparatus, to control the output interface, the image shooting operation including a plurality of times of imaging by the image sensor for modeling the subject. The controller causes the output interface to output shooting guide information, according to the recognized situation in the image shooting operation, the shooting guide information guiding the user to succeed in shooting of each of a plurality of images for modeling of the subject according to a situation recognized in the image shooting operation.

According to a second aspect, in the imaging apparatus according to the first aspect, the shooting guide information includes map information indicating a successful region and an unsuccessful region respectively in a plurality of regions corresponding to the plurality of images for modeling of the subject, the successful region being a region where the image shooting for modeling is successful, and the unsuccessful region being a region where the image shooting for modeling is not successful.

According to a third aspect, in the imaging apparatus according to the second aspect, a successful region and an unsuccessful region are arranged along a three-dimensional shape of a subject in the map information.

According to a fourth aspect, in the imaging apparatus according to any of the first to third aspects, the shooting guide information includes a pointer indicating a position corresponding to an image being shot by the user in the map information associated with a subject.

According to a fifth aspect, in the imaging apparatus according to the fourth aspect, the map information includes a plurality of regions corresponding to a plurality of images for modeling of a subject, each of a plurality of the regions in the map information has size indicating a predetermined distance, and the controller controls size of the pointer according to a distance between the subject and the imaging apparatus.

According to a sixth aspect, in the imaging apparatus according to any of the first to fifth aspects, the controller controls the shooting guide information so as to notify precautions causing failure of image shooting for modeling of a subject according to a situation recognized in the image shooting operation.

According to a seventh aspect, in the imaging apparatus according to any of the first to sixth aspects, when image shooting for modeling of a subject fails, the controller controls the shooting guide information so as to notify a factor of failure of the image shooting.

According to an eighth aspect, in the imaging apparatus according to any of the first to seventh aspects, the controller generates shooting data including first and second images having different image qualities as a result of the image shooting operation. Image quality of the second image is more suitable for information processing for modeling than image quality of the first image.

According to a ninth aspect, in the imaging apparatus according to any of the first to eighth aspects, the controller removes a specific image from all images shot in the image shooting operation to generate shooting data indicating a remaining image. The specific image includes at least one of a failed image or an overlap image, the failed image being obtained when image shooting for modeling of a subject fails, and the overlap image having a positional relation duplicate with the remaining image, the positional relation being defined between the subject and the imaging apparatus at the time of shooting.

According to a tenth aspect, in the imaging apparatus according to any of the first to ninth aspects, the image shooting operation includes a plurality of times of imaging with predetermined shooting setting for a plurality of shooting portions in a subject. The controller controls the image shooting operation to perform image shooting with additional shooting setting different from the predetermined shooting setting in addition to image shooting with the predetermined shooting setting, with respect to a specific shooting portion among a plurality of shooting portions. The specific shooting portion has a feature amount for modeling that is less than a predetermined value in an image shot with the predetermined shooting setting.

According to an eleventh aspect, in the imaging apparatus according to the tenth aspect, the controller controls the shooting guide information to instruct the user to pause for image shooting with additional shooting setting.

A twelfth aspect is an imaging apparatus that performs image shooting for modeling of a subject. The imaging apparatus includes an image sensor that images a subject and generates image data, and a controller that controls image shooting operation including a plurality of times of imaging with predetermined shooting setting for a plurality of shooting portions in the subject for modeling of the subject. The controller controls the image shooting operation so as to perform image shooting with additional shooting setting different from the predetermined shooting setting in addition to image shooting with the predetermined shooting setting, with respect to a specific shooting portion among a plurality of shooting portions. The specific shooting portion has a feature amount for modeling that is less than a predetermined value in an image shot with the predetermined shooting setting.

According to a thirteenth aspect, in the imaging apparatus according to any of the tenth to twelfth aspects, the controller controls the image shooting operation so as not to perform image shooting with additional shooting setting and to perform image shooting with predetermined shooting setting, with respect to another shooting portion than a specific shooting portion among a plurality of shooting portions.

According to a fourteenth aspect, in the imaging apparatus according to any of the tenth to thirteenth aspects, the controller detects failure or success in image shooting with predetermined shooting setting, with respect to each shooting portion in the image shooting operation. In a case where failure of image shooting is detected, the controller controls the image shooting operation so that image shooting with predetermined shooting setting is performed again on the shooting portion, and in a case where success of image shooting is detected, when the shooting portion is a specific shooting portion, image shooting with additional shooting setting is performed in addition to image shooting with the predetermined shooting setting.

According to a fifteenth aspect, in the imaging apparatus according to any of the tenth to fourteenth aspects, the controller controls the image shooting operation such that first and second images having mutually different image qualities are shot with predetermined shooting setting with respect to a shooting portion other than a specific shooting portion among a plurality of shooting portions, and the first image is shot with predetermined shooting setting and the second image is shot with additional shooting setting with respect to the specific shooting portion.

As described above, the embodiment is described as an exemplification of the technique in the present disclosure. For this purpose, the accompanying drawings and the detailed description are provided.

Accordingly, the constituents described in the accompanying drawings and the detailed description may include not only a constituent essential for solving the problem, but also a constituent not essential for solving the problem in order to exemplify the technique. For this reason, it should not be recognized that those non-essential constituents are essential just because those non-essential constituents are described in the accompanying drawings and the detailed description.

In addition, since the above embodiment is for illustrating the technique in the present disclosure, various changes, substitutions, additions, omissions, and the like can be made within the scope of the claims or the equivalent thereof.

The present disclosure is applicable to various applications in which image shooting for modeling a subject is performed.

1. An imaging apparatus for causing a user to perform image shooting for modeling of a subject, the imaging apparatus comprising:
an image sensor configured to capture an image of a subject to generate image data;
an output interface configured to output information to the user; and
a controller configured to recognize a situation in which image shooting operation is executed by the imaging apparatus, to control the output interface, the image shooting operation including a plurality of times of imaging by the image sensor for modeling the subject,
wherein the controller is configured to cause the output interface to output shooting guide information, according to the recognized situation in the image shooting operation, the shooting guide information guiding the user to succeed in shooting of each of a plurality of images for modeling of the subject.

2. The imaging apparatus according to claim 1, wherein the shooting guide information includes map information indicating a successful region and an unsuccessful region respectively in a plurality of regions corresponding to the plurality of images for modeling of the subject, the successful region being a region where the image shooting for modeling is successful, and the unsuccessful region being a region where the image shooting for modeling is not successful.

3. The imaging apparatus according to claim 2, wherein the successful region and the unsuccessful region are arranged along a three-dimensional shape of the subject in the map information.

4. The imaging apparatus according to claim 1, wherein the shooting guide information includes a pointer indicating a position corresponding to an image being shot by the user in map information associated with the subject.

5. The imaging apparatus according to claim 4, wherein
the map information includes a plurality of regions corresponding to the plurality of images for modeling of the subject,
each of the plurality of the regions in the map information has size indicating a predetermined distance, and
the controller is configured to control size of the pointer according to a distance between the subject and the imaging apparatus.

6. The imaging apparatus according to claim 1, wherein the controller is configured to control the shooting guide information to notify precautions to be failure of the image shooting for modeling of the subject, according to the recognized situation in the image shooting operation.

7. The imaging apparatus according to claim 1, wherein, the controller is configured to control, in response to causing failure of the image shooting for modeling of the subject, the shooting guide information to notify a factor for the failure of the image shooting.

8. The imaging apparatus according to claim 1, wherein
the controller is configured to generate shooting data as a result of the image shooting operation, the shooting data including first and second images having different image qualities from each other, and
the image quality of the second image is more suitable for information processing for modeling than the image quality of the first image.

9. The imaging apparatus according to claim 1, wherein the controller is configured to remove a specific image from all images shot in the image shooting operation to generate shooting data indicating a remaining image, and
the specific image includes at least one of a failed image or an overlap image, the failed image being obtained when the image shooting for modeling of the subject fails, and the overlap image having a positional relation duplicate with the remaining image, the positional relation being defined between the subject and the imaging apparatus at the time of shooting.

10. The imaging apparatus according to claim 1, wherein
the image shooting operation includes a plurality of times of imaging based on predetermined shooting setting for a plurality of shooting portions in the subject,
in addition to the image shooting based on the predetermined shooting setting, the controller is configured to control the image shooting operation to perform additional image shooting with respect to a specific shooting portion among the plurality of shooting portions, the additional image shooting based on additional shooting setting that is different from the predetermined shooting setting, and
the specific shooting portion has a feature amount for modeling that is less than a predetermined value in an image shot based on the predetermined shooting setting.

11. The imaging apparatus according to claim 10, the controller is configured to control the shooting guide information to instruct the user to pause for the additional image shooting based on the additional shooting setting.

12. An imaging apparatus for performing image shooting for modeling of a subject, the imaging apparatus comprising:
an image sensor configured to capture an image of a subject to generate image data; and
a controller configured to control image shooting operation for modeling of the subject, the image shooting operation including a plurality of times of imaging based on predetermined shooting setting for a plurality of shooting portions in the subject, wherein
in addition to the image shooting based on the predetermined shooting setting, the controller is configured to control the image shooting operation to perform additional image shooting with respect to a specific shooting portion among the plurality of shooting portions, the additional image shooting based on additional shooting setting that is different from the predetermined shooting setting, and
the specific shooting portion has a feature amount for modeling that is less than a predetermined value in an image shot based on the predetermined shooting setting.

13. The imaging apparatus according to claim 12, wherein with respect to another shooting portion than the specific shooting portion among the plurality of shooting portions, the controller is configured to control the image shooting operation to perform the image shooting based on the predetermined shooting setting, without performing the additional image shooting.

14. The imaging apparatus according to claim 12, wherein
the controller is configured to detect failure or success in the image shooting based on the predetermined shooting setting for each shooting portion in the image shooting operation, wherein
the controller is configured to control the image shooting operation to:
in a case where the failure of image shooting is detected, perform the image shooting based on the predetermined shooting setting again, with respect to the shooting portion; and
in a case where the success of image shooting is detected, perform the additional image shooting based on the additional shooting setting, in response to the shooting portion being the specific shooting portion, in addition to the image shooting based on the predetermined shooting setting.

15. The imaging apparatus according to claim 12, wherein
the controller is configured to control the image shooting operation to:
shoot first and second images based on the predetermined shooting setting, with respect to another shooting portion than the specific shooting portion among the plurality of shooting portions, the first and second images having mutually different image qualities; and
shoot the first image based on the predetermined shooting setting and the second image based on the additional shooting setting, with respect to the specific shooting portion.
